(19) United States
(12) Patent Application Publication
(10) Pub. No.: US 2015/0215216 A1
(43) Pub. Date: Jul. 30, 2015

(54) Call Connection Establishment Via Service Specific Access Control

(71) Applicant: Broadcom Corporation, Irvine, CA (US)

(72) Inventors: Ozgur EKICI, San Diego, CA (US); Kavya Budugutta Ravikumar, San Diego, CA (US)

(73) Assignee: Broadcom Corporation, Irvine, CA (US)

(21) Appl. No.: 14/525,004

(22) Filed: Oct. 27, 2014

Related U.S. Application Data
(60) Provisional application No. 61/931,275, filed on Jan. 24, 2014.

(51) Int. Cl. H04L 12/851; H04W 76/04; H04W 28/02; H04W 72/10

(52) U.S. Cl. CPC H04L 47/2433; H04W 72/10; H04W 76/046; H04W 28/0289

(57) ABSTRACT

A method and apparatus is disclosed to prioritize certain types of traffic, such as voice traffic or video traffic, to provide some examples, over other types of traffic, such as data traffic, to provide an example, within one or more of the cells during the period of high volume of traffic, for example, during the foreseeable and/or the unforeseeable events. The traffic within the communication network can be monitored and the prioritization of the traffic can be dynamically changed based upon the type and volume of traffic or the prioritization of the traffic can be preemptively changed based upon a foreseeable event.

### CROSS-REFERENCE TO RELATED APPLICATIONS

The present application claims the benefit of U.S. Provisional Patent Appl. No. 61/931,275, filed Jan. 24, 2014, which is incorporated herein by reference in its entirety.

### BACKGROUND

1. Field of Disclosure

The present disclosure relates generally to the prioritizing of traffic in a cellular network.

2. Related Art

A cellular network is a wireless network distributed over a geographic area that is divided into cells. Each cell is served by at least one fixed-location transceiver, known as a base station. The base station is responsible for handling traffic and signaling between communication devices and a network switching subsystem. When joined together, the cells provide communications over a wide geographic area. This enables mobile communication devices, such as mobile cellular telephones, to communicate with each other, with base stations, and/or with other communication devices within the cellular network.

A mobile cellular telephone, also known as a cellular phone, cell phone, hand phone, or mobile communication device, is a device that can make and receive telephone calls over a radio link while moving around a wide geographic area. Mobile cellular telephones, as well as mobile communication devices in general, can connect to a public switched telephone network or to a public Internet through the cellular network. By using the cellular network, mobile communication devices can transmit, for example, voice traffic such as real time speech or voice recordings, video traffic, and data traffic.

During emergency situations, like storms or in unusual or popular events like New Year's day celebrations affecting large areas, the number of voice calls and video calls is likely to increase greatly as many people attempt to make a voice call or a video call at this time. During such events, many people prefer to make a real-time connection with another person by using their mobile communication device. In such use case scenarios, cellular networks are prone to congestion and voice calls and video calls can have difficulty being transmitted due to limited network resources.

### BRIEF DESCRIPTION OF THE DRAWINGS/FIGURES

The present disclosure is described with reference to the accompanying drawings. In the drawings, like reference numbers indicate identical or functionally similar elements. Additionally, the left most digit(s) of a reference number identifies the drawing in which the reference number first appears.

FIG. 1 illustrates a representative communication network environment according to an example embodiment;

FIG. 2A illustrates a block diagram for a mobile communication device according to an example embodiment;

FIG. 2B illustrates a block diagram for a base station according to an example embodiment;

FIG. 3 is a flow chart illustrating a method to prioritize traffic in a cellular network according to an example embodiment;

FIG. 4 illustrates a functional block diagram for mobile communication device modules according to an example embodiment; and

FIG. 5 illustrates a functional block diagram for a radio resource control (RRC) layer according to an example embodiment.

The present disclosure will now be described with reference to the accompanying drawings. In the drawings, like reference numbers generally indicate identical, functionally similar, and/or structurally similar elements.

### DETAILED DESCRIPTION OF THE DISCLOSURE

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the present disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

Moreover, terms like “user equipment,” “mobile station,” “mobile,” “mobile communication device,” “subscriber station,” “subscriber equipment,” “access terminal,” “terminal,” “handset,” and similar terminology refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B.” “evolved Node B (eNode B),” home Node B (HNB),” “home access point (HAP),” or the like are utilized interchangeably in the subject specification and drawings, and refer to a wireless network component or apparatus that serves and receives data, control, voice, video, sound, gaming, or substantially any data-stream or signaling-stream from a set of subscriber stations.

Overview

The present disclosure allows for a method and apparatus to prioritize certain types of traffic, such as voice traffic or video traffic, to provide some examples, over other types of traffic, such as data traffic, to provide an example, within a cellular network during a period of high traffic volume, for example, during an event. The present disclosure, for example, can allow high priority traffic, such as the voice traffic or the video traffic, to enter into the cellular network while lower priority traffic, such as the data traffic, to provide an example, is prevented from entering into the cellular network. The communication network can monitor the traffic within the communication network and can dynamically change the prioritization of the traffic or preemptively change the prioritization of the traffic.

During an event, such as an emergency event or an unusual or a popular event to provide some examples, many observers are likely to communicate their experiences to others using the communication network which can cause traffic within the communication network to increase and the communication network can become congested. Network congestion can happen, for example, when a large amount of traffic almost simultaneously enters into the communication network.

At these times, the communication network experiences a period of high traffic volume that exceeds the traffic experienced by the communication network when the event is not occurring. The communication network can prioritize certain types of traffic, such as the voice traffic or the video traffic, to provide some examples, over other types of traffic, such as the data traffic, to provide an example, to increase the likelihood of the prioritized traffic making it through the communication network during the period of high volume of traffic. High priority traffic, such as the voice traffic or the video traffic, to provide some examples, is allowed to enter into the communication network while lower priority traffic, such as the data traffic, to provide an example, is prevented from entering into the communication network. The communication network can continue this prioritization until the period of high volume of traffic subsides whereby the communication network no longer prioritizes traffic.

The traffic within the communication network can be monitored and the prioritization of the traffic can be dynamically changed. In an exemplary embodiment, the event can be characterized as being a foreseeable event, such as a sporting contest, a specific day or time like Mother's Day or New Year's Eve, a musical concert, a speech, a movie, or a television show, to provide some examples, or an unforeseeable event, such as a natural disaster event, a spontaneous public event, or an emergency event to provide some examples. In this exemplary embodiment, the prioritization of the traffic by the communication network can be preemptively predetermined to be prioritized for the duration of the foreseeable event. Optionally, the traffic within the communication network can be monitored and the prioritization of the traffic can be dynamically changed during the foreseeable event. Additionally, or in another exemplary embodiment, the communication network cannot preemptively determine to prioritize the traffic for the unforeseeable event. The traffic within the communication network can be monitored and the prioritization of the traffic can be dynamically changed during the unforeseeable event. For example, the communication network can prioritize the voice traffic or the video traffic over the data traffic. In this example, if the volume of traffic were to increase from the high volume of traffic to an even higher volume of traffic, the communication network can dynamically change its prioritization to prioritize the voice traffic over the video traffic and the data traffic to prevent the video traffic and the data traffic from entering the communication network. In this example, if the volume of traffic were to decrease from the high volume of traffic to a lower volume of traffic, the communication network can dynamically cease to prioritize the voice, the video, and the data traffic.

Cellular Network Environment According to an Exemplary Embodiment

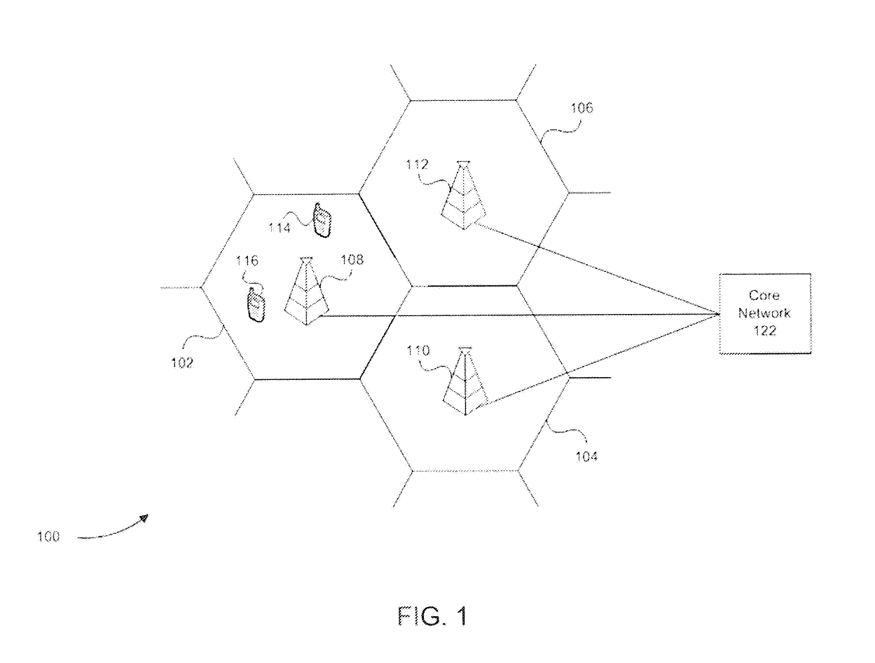

FIG. 1 illustrates a cellular network 100 according to an exemplary embodiment of the present disclosure. The cellular network 100 is distributed over cells 102, 104, and 106 that are each served by a respective base station 108, 110, 112. The cells 102, 104, and 106 enable mobile communication devices 114, 116, such as mobile phones, laptops, tablets, pagers, or any other device having wireless communication capability to provide some examples, to wirelessly communicate over a wide geographical area with a core network 122 via the base stations 108, 110, 112. It should be noted that the cellular network 100 can include any suitable number of cells, base stations, and/or mobile communication devices.

The cellular network 100 can be operated in accordance with any one of a number of different cellular network standards, including one of the current or yet to be released versions of the long-term evolution (LTE) standard, or combinations of the different cellular network standards. According to the LTE standard, traffic is communicated within a conventional cellular network as packets irrespective of whether the traffic is voice traffic, video traffic, or data traffic. As a result, congestion can occur within the conventional cellular network during periods of high volume of traffic, especially when there is no restriction on the types of traffic that can enter into the conventional cellular network. As to be discussed below, the cellular network 100 can prioritize certain types of traffic, such as the voice traffic or the video traffic, to provide some examples, over other types of traffic, such as the data traffic, to provide an example, which can be advantageous in preventing congestion within the cellular network 100 especially during the period of high traffic volume. In an exemplary embodiment, the cellular network 100 can be operated in accordance with a modified version of the LTE standard to allow for prioritization of traffic.

As illustrated in FIG. 1, the base stations 108, 110, 112 and/or core network 122 can prioritize certain types of traffic, such as voice traffic or video traffic, to provide some examples, over other types of traffic, such as data traffic, to provide an example, within one or more of the cells 102, 104, and 106 during the period of high volume of traffic, for example, during the foreseeable and/or the unforeseeable events. For example, the base stations 108, 110, 112 and/or the core network 122 can provide a prioritization command to one or more of the mobile communication devices 114, 116 to cause the one or more of the mobile communication devices 114, 116 to prioritize their respective traffic according to the prioritization command. In response, the one or more of the mobile communication devices 114, 116 can allow high priority traffic, such as the voice traffic or the video traffic, to enter into the cellular network 100 while lower priority traffic, such as the data traffic to provide an example, is prevented from entering into the cellular network 100.

Optionally, the prioritization command can include a duration for which the prioritization by the one or more of the mobile communication devices 114, 116 is to continue. Additionally, the base stations 108, 110, 112 and/or the core network 122 can provide a second prioritization command to the cause the one or more of the mobile communication devices 114, 116 to cease prioritizing their traffic. In an exemplary embodiment, the base stations 108, 110, 112 and/or the core network 122 can monitor traffic within the cellular network 100 and the prioritization of the traffic can be dynamically changed, based upon type and volume of traffic, by the base stations 108, 110, 112 and/or the core network 122 providing a new prioritization command to the one or more of the mobile communication devices 114, 116.

The mobile communication devices 114, 116 can connect to each other using the base stations 108, 110, 112 and/or the core network 122. The mobile communication devices 114, 116 can transmit and receive, for example, voice traffic, video traffic, and data traffic. In the present disclosure, data traffic constitutes non-voice traffic and non-video traffic, such as, for example, information associated with various websites, such as a personal website, a commercial website; such as a social media website or a news reporting website; a government website; a nonprofit organization website; and/or any other suitable website. This other suitable website can include a static website that usually displays the same information to all visitors or a dynamic website that changes or customizes itself frequently and/or automatically.

Exemplary Mobile Communication Device

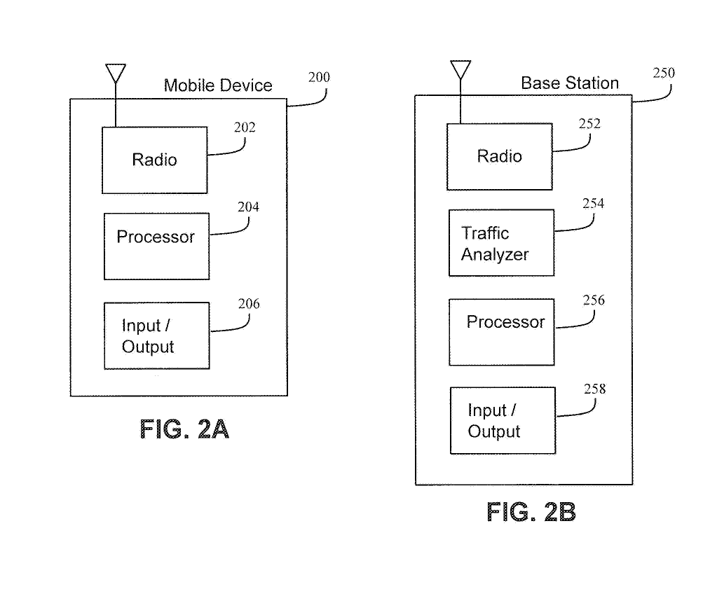

FIG. 2A illustrates is a block diagram of a mobile communication device according to an example embodiment. A mobile communication device 200 can receive one or more prioritization commands from a base station and/or a core network within a cellular network, such as the cellular network 100 to provide an example. The mobile communication device 200 can prioritize certain types of traffic, such as the voice traffic or the video traffic, to provide some examples, over other types of traffic, such as the data traffic, to provide an example, in response to the one or more prioritization commands. Thereafter, the mobile communication device 200 can allow high priority traffic, such as the voice traffic or the video traffic, to enter into the cellular network while lower priority traffic, such as the data traffic, to provide an example, is prevented from entering into the cellular network. The mobile communication device 200 includes one or more wireless radios 202, one or more processors 204, and input/output components 206. The mobile communication device 200 can represent an exemplary embodiment of the mobile communication device 114 and/or 116.

The mobile communication device 200 can be configurable to operate in a normal mode of operation whereby traffic is not prioritized and/or in a prioritized mode of operation whereby traffic is prioritized. In the normal mode of operation, the mobile communication device 200 communicates traffic within the cellular network in accordance with any one of a number of different cellular network standards, including one of the current or yet to be released versions of the LTE standard, or combinations of the different cellular network standards. However, in the prioritized mode of operation, the mobile communication device prioritizes certain types of traffic, such as the voice traffic or the video traffic, to provide some examples, over other types of traffic, such as the data traffic, to provide an example, in response to the one or more prioritization commands.

Specifically, the one or more radios 202 can transmit and/or receive traffic within the cellular network. This traffic can include voice traffic, video traffic, data traffic, and/or command traffic. In an exemplary embodiment, the one or more radios 202 can transmit voice traffic, video traffic, data traffic in a Physical Uplink Shared Channel (PUSCH) of the LTE standard to the cellular network and/or receive voice traffic, video traffic, data traffic in a Physical Downlink Shared Channel (PDSCH) from the cellular network. In this exemplary embodiment, the one or more radios 202 can receive the command traffic, such as the one or more prioritization commands, in a Physical Downlink Control Channel (PDCCH) of the LTE standard from the cellular network. The one or more radios 202 can include one or more transmitters to process traffic to be provided to the cellular network and one or more receivers to process traffic received from the cellular network.

The one or more processors 204 can include, for example, components for facilitating voice calls, video calls, and data traffic, for processing images, for handling packet switched services, and for executing firmware. These components can cause the mobile communication device 200 to enter into the prioritized mode of operation upon receiving a first prioritization command from the one or more radios 202. In the prioritized mode of operation, the one or more processors 204 can classify traffic to be provided to the cellular network as being voice traffic, video traffic, and/or data traffic. Thereafter, the one or more processors 204 can allow certain types of traffic, such as the voice traffic or the video traffic, to be passed onto the one or more radios 202 for transmission to the cellular network or prevent other types of traffic, such as the data traffic, from being passed onto the one or more radios 202 in accordance with the first prioritization command. The first prioritization command can optionally include a duration for which the mobile communication device 200 is to remain in the prioritized mode of operation. Alternatively, the one or more processors 204 can receive a second prioritization command from the one or more radios whereby the mobile communication device 200 is to return to the normal mode of operation.

The input/output components 206 can include, for example, a microphone, user input buttons (physical or via a touch screen), a global positioning system (GPS), a digital camera, a wireless LAN (WiFi) interface, a motion sensor, a Bluetooth® interface, a USB or similar port, a speaker, headphone or headset jack adapter, visual display, and/or a haptic technology output device (e.g., a vibrator). The input/output components 206 can provide a notification to a user of the mobile communication device 200 that the mobile phone 200 is operating in either the normal mode of operation or the prioritized mode of operation. This notification can represent activation of a visual icon on a visual display or an audio signal being played through the speaker. The notification can additionally communicate to the user types of traffic that are allowed to enter into the cellular network or are prevented from entering into the cellular network. The notification can further communicate to the user whether particular communication from the user or from the cellular network is prevented.

While various components, features, and functions of the mobile communication device 200 have been described in the implementation illustrated in FIG. 2A, it should be understood that numerous other configurations, components, features, and the like may be incorporated into the mobile communication devices described herein, and that the implementations described herein are not limited to any particular configuration for the mobile communication devices.

Exemplary Base Station

FIG. 2B illustrates is a block diagram of a base station according to an example embodiment. A base station 250 can transmit one or more prioritization commands received from a network operator or a core network within a cellular network, such as the cellular network 100 to provide an example. The base station 250 can cause mobile communication devices in communication with it to prioritize certain types of traffic, such as the voice traffic or the video traffic, to provide some examples, over other types of traffic, such as the data traffic, to provide an example, which can be advantageous in preventing congestion within a cellular network especially during the period of high volume of traffic. Optionally, the base station 250 can monitor traffic within the cellular network and base station 250 can cause the mobile communication devices to dynamically change the prioritization of the traffic based upon type and volume of traffic within the communications network. The base station 250 includes one or more wireless radios 252, one or more traffic analyzers 254, one or more processors 256, and input/output components 258. The base station 250 can represent an exemplary embodiment of the base station devices 108, 110, and/or 112.

The base station 250 can cause the mobile communication devices to operate in the normal mode of operation, as discussed in FIG. 2A, whereby traffic is not prioritized and/or in the prioritized mode of operation, as discussed in FIG. 2A, whereby traffic is prioritized. The one or more radios 252 can include one or more transmitters and one or more receivers to provide and/or receive, respectively, traffic and commands. Specifically, the one or more radios 252 can transmit control information, such as one or more of the prioritization commands as discussed above, to the mobile communication devices. In addition, the base station 250 can receive traffic, such as the voice traffic, the video traffic, the data traffic, and/or the command traffic, from the mobile communication devices. The command traffic from the mobile communication device can include, for example, call initiation requests. In an exemplary embodiment, the one or more radios 252 can transmit the one or more of the prioritization commands in a broadcast of system information using a Physical Broadcast Channel (PBCH) in accordance with the LTE standard.

The one or more traffic analyzers 254 can include, for example, components, such as a network analyzer, communication analyzer, spectrum analyzer, and bit error rate tester, to monitor health, status, and usage of the cellular network. For example, the one or more traffic analyzers 254 can monitor the traffic within the cellular network and can request the one or more processors 256 to dynamically change the prioritization of the traffic. In this example, when the volume of traffic within the cellular network exceeds a first threshold value, the one or more traffic analyzers 254 may request that the one or more processors 256 cause the base station 250 to place the mobile communication devices in a first prioritized mode of operation. Alternatively, should the network traffic increase above a second threshold level, the one or more traffic analyzers 254 may request that the one or more processors 256 cause the base station 250 to place the mobile communication devices in a second prioritized mode of operation. The mobile communication devices prioritize the voice traffic and video traffic over data traffic in the first prioritized mode of operation whereas the mobile communication devices prioritize voice traffic over the video traffic and the data traffic in the second prioritized mode of operation. Alternatively, if the volume of traffic were to decrease from the high volume of traffic to a lower volume of traffic, for example, below the first threshold value, the one or more traffic analyzers 254 may request that the one or more processors 256 cause the base station 250 to return the mobile communication devices to the normal mode of operation as discussed above in FIG. 2A.

The one or more processors 256 can include, for example, components to command base station operations, to interface to a core network, to interface with the one or more traffic analyzers 254, to interface with a network operator, to determine traffic prioritization based on the cellular network usage, cellular network capacity, and cellular network operating ground rules, and to execute code and firmware provided by the network operator or core network. The one or more processors 256 can cause the mobile communication devices to enter into the prioritized mode of operation upon receiving a first prioritization command from the base station network operator or the core network via the base station input/output components 258. The first prioritization command can additionally can be derived from information received by the one or more traffic analyzers 254. The first prioritization command is communicated to the mobile communication devices using the one or more wireless radios 252. In the prioritized mode of operation, the one or more processors 256 can cause the mobile communication devices to transmit only certain types of traffic, such as the voice traffic or the video traffic, to the one or more radios 252. The first prioritization command can optionally include a duration for which the mobile communication devices are to remain in the prioritized mode of operation. Alternatively, the one or more processors 256 can have the one or more wireless radios 252 transmit a second prioritization command whereby the one or more mobile communication devices are to return to the normal mode of operation, as discussed above.

The input/output components 258 can include, for example, a wireless a LAN (WiFi) interface, a LAN interface, a WAN interface, an Ethernet interface, a Bluetooth® interface, a USB or similar port, user input buttons (physical or via a touch screen), and/or visual display. The input/output components 258 can provide a notification to the network operator or the core network that a base station 250 is causing mobile communication devices to operate in either the normal mode of operation or the prioritized mode of operation. The notification can additionally communicate to the network operator or the core network the types of traffic that are being allowed to enter into the cellular network or are prevented from entering into the cellular network. The notification can further communicate to the network operator or the core network whether a particular communication from the mobile communication device or from the cellular network is prevented. Additionally, the network operator can use the input/output components 258 to command the one or more processors 256 to cause the mobile communication devices to enter into the prioritized mode of operation which can be advantageous before the occurrence of the foreseen event to preemptively change the prioritization of the traffic.

While various components, features, and functions of the base station 250 have been described in the implementation illustrated in FIG. 2B, it should be understood that numerous other configurations, components, features, and the like may be incorporated into the base station described herein, and that the implementations described herein are not limited to any particular configuration for the base stations.

Method for Prioritizing Traffic in a Communication Network

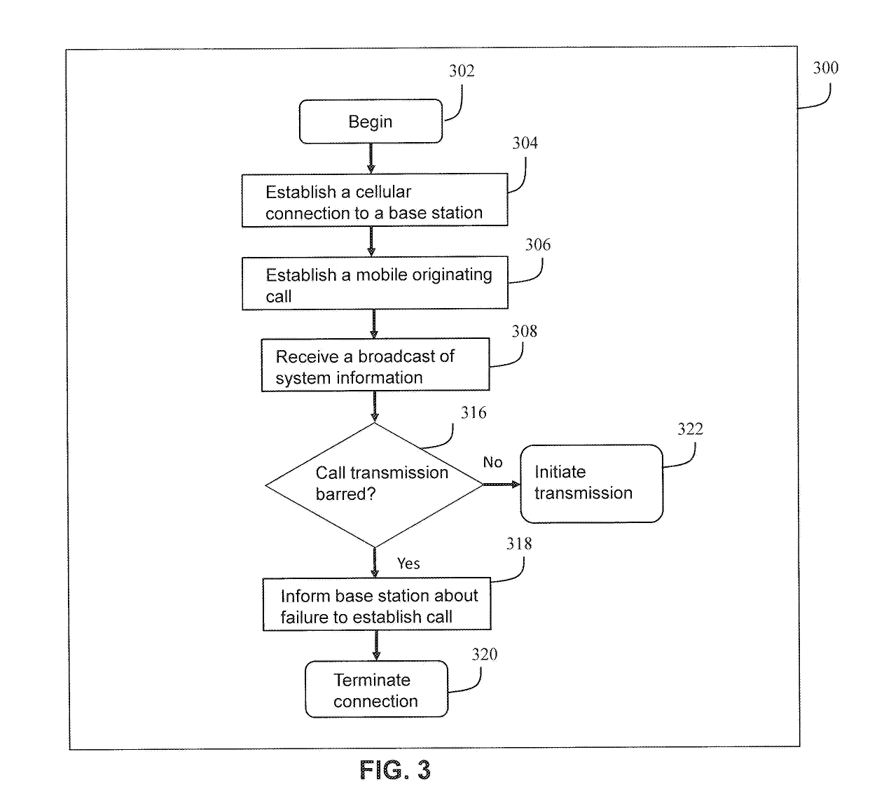

FIG. 3 is a flow chart illustrating a method 300 to prioritize traffic in a cellular network using a radio resource control (RRC) protocol connection according to an example embodiment. The RRC protocol is a communication protocol that handles call signaling between the mobile communication device and the base station. The RRC protocol includes functions for call connection establishments and release, handling broadcasts of system information from the base stations, radio bearer establishment and release, connection mobility procedures, paging notification and release, and outer loop power control.

The method 300 performs traffic prioritizing using, for example, a RRC protocol of the LTE standard, including one of the current or yet to be released versions of the long-term evolution (LTE) standard, or combinations of the different cellular network standards. The method 300 can be used in a mobile communication device, such as the mobile communication device 200, that is operating in accordance with the LTE standard. The method 300 describes, for example, prioritization of traffic by the mobile communication devices in the cellular network, whereby the mobile communication device can prioritize certain types of traffic, such as the voice traffic or the video traffic, to provide some examples, over other types of traffic, such as the data traffic, to provide an example, in response to one or more prioritization commands, as discussed in FIG. 1, FIG. 2A, and FIG. 2B above.

In this exemplary embodiment, the cellular network can prioritize certain types of traffic through the use of prioritization commands, such as barring durations received in a broadcast of system information from the base station to provide an example. The method 300 begins with step 302. Thereafter, at step 304, the mobile communication device establishes a cellular connection with a base station in the cellular network in accordance with the LTE standard. At step 306, the mobile communication device then establishes a mobile originating call with the base station using the RRC protocol. As part of establishing the mobile originating call, the mobile communication device receives a broadcast of system information from the base station at step 308. Included in the broadcast of system information is traffic prioritization commands, such as call barring durations, associated with different types of traffic, such as voice traffic, video traffic, and data traffic, in the cellular network.

At step 316, the mobile communication device checks whether the mobile originating call is a voice call, a video call, or a data call. The mobile communication device determines traffic priority and/or calculates the barring durations from the prioritization commands received in the broadcast of system information from step 308 and thereafter sets priority and/or starts the barring duration for that call at step 316. The barring duration represents the time for which traffic is barred from transmission. If the voice traffic, video traffic, or data traffic is not barred, transmission of the call is initiated and the call is allowed to go through at step 322. If voice traffic, video traffic, or data traffic is barred for a barring duration that exceeds the RRC connection request/retransmit timer for the mobile communication device, the call will timeout and the call will fail to transmit at step 318 and the call will terminate at step 320. The RRC connection request/retransmit timer determines how long the mobile communication device waits for the RRC connection setup after sending an RRC connection setup request to the base station. Traffic transmission can be barred for a number of reasons, for example, if access to the cell is barred, the call barring parameters preclude transmission, the prioritization commands allow other traffic to transmit, or if the traffic type is incompatible with the communication network.

Exemplary Mobile Communication Device Traffic Prioritization Modules

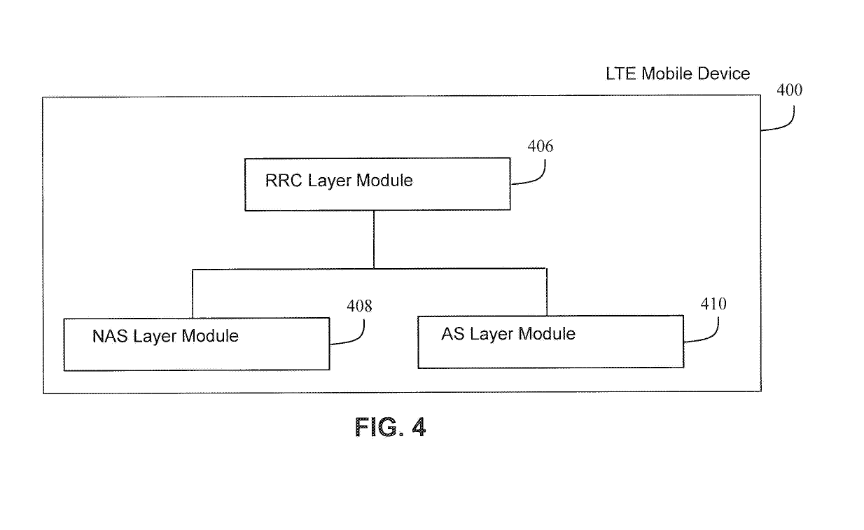

FIG. 4 illustrates a functional block diagram for a mobile communication device 400 that operates in accordance with the LTE standard according to an example embodiment. As shown in FIG. 4, the functionality of a mobile communication device 400 includes, for example, an Access Stratum (AS) layer module 410 that communicates between the mobile communication device 400 and the radio access core network (not shown) via the base station (not shown). The AS layer module 410 is responsible for transporting data over the wireless connection and managing radio resources. Also included, for example, is a Non-Access Stratum (NAS) layer module 408 that is used to manage the establishment of communication sessions and for maintaining continuous communications with the mobile communication device 400 as it moves around the geographic area.

The mobile communication device 400, for example, includes an RRC layer module 406. The RRC layer module 406 communicates to the NAS layer module 408 and to the AS layer module 410.

The RRC layer module 406 and the NAS layer module 408 can be implemented within one or more processors, such as the one or more processors 204 to provide an example, within the mobile communication device 400 and/or the AS layer module 410 can be implemented within a radio, such as the one or more radios 202 to provide an example, within the mobile communication device 400. In an exemplary embodiment, the RRC layer module 406 transmits traffic associated with a call in the mobile communication device using the AS layer module 410. In an exemplary embodiment, the RRC layer module 406 receives and implements commands sent from the base station contained within the broadcast of system information which are derived by the non-access stratum NAS layer module 408. The commands derived by the NAS layer module 408, for example, control paging, control call establishment can prioritize voice traffic, video traffic, and data traffic, and control the maintenance and release of a connection between the mobile communication device 400 and the base station. The RRC layer module 406 can be used to implement an exemplary embodiment method for prioritizing traffic in a communication network 300.

Exemplary Radio Resource Control Layer Module

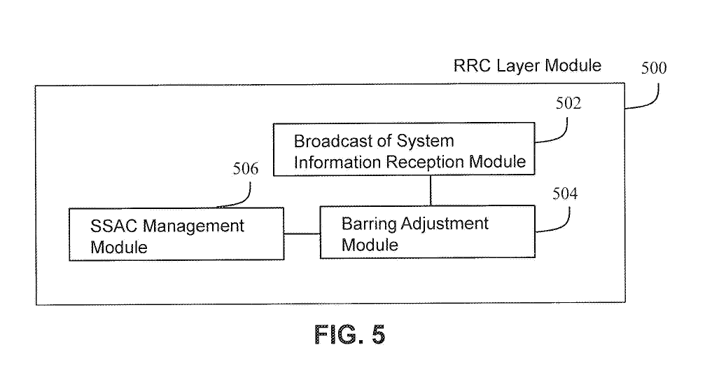

FIG. 5 illustrates a functional block diagram for a radio resource control (RRC) layer module according to an example embodiment. A RRC layer module 500 includes a broadcast of system information reception module 502, a barring adjustment module 504, and a Service Specific Access Control (SSAC) management module 506. The RRC layer module 500 can represent an exemplary embodiment of the one or more processors 204.

The broadcast of system information reception module 502 is configured to receive a broadcast of system information transmitted by the base station to the mobile communication devices. The broadcast of system information reception module 502 determines what commands as being sent by the base station to configure the mobile communication devices associated with the base station. The broadcast of system information reception module 502 determines if the broadcast of system information contains any parameters associated with traffic prioritization, such as barring durations, for example, and passes this information to the barring adjustment module 504. The broadcast of system information reception module 502, for example, can represent an exemplary embodiment of NAS layer module 408.

The barring adjustment module 504 generates the barring duration(s) based on the received prioritization commands associated with a broadcast of system information. Received prioritization commands, for example, can include the barring durations ssac-BarringForMMTEL-Voice for voice traffic and ssac-BarringForMMTEL-Video for video traffic. The prioritization commands, for example, can be part of the SystemInformationBlockType2 (SIB2) information included in a broadcast of system information. The barring adjustment module 504 may be configured to generate a barring duration for each type of mobile originating call separately, for example, a barring duration for voice traffic, video traffic, and data traffic. The barring adjustment module 504 passes the barring durations to the SSAC management module 506. The barring adjustment module 504, for example, can represent an exemplary embodiment of NAS layer module 408.

The SSAC management module 506 manages the access control of the mobile communication device. The SSAC management module 506 manages the prioritization of the voice traffic, video traffic, and data traffic by using the barring durations generated by the barring adjustment module 504 and/or by prioritization commands received in the broadcast of system information module 502. The SSAC management module 506 also aims to minimize the probability of collision in the case of several transmissions at the same time in the same random access channel resource between the mobile communication device and the base station. In addition barring parameters, included in the broadcast of system information from the base station can be an access class factor p (which is a probability of access) to the mobile communication devices, for example, to determine traffic prioritization. In an exemplary embodiment, the mobile communication device generates a random number n for voice traffic, video traffic, and data traffic, based on parameters in the broadcast of system information. The mobile communication device then decides locally whether it can proceed to the random channel access and make the mobile originating call by comparing n to p. If this random number n, is equal to or greater than p, then access is barred for a mean access barring time duration. The SSAC management module 506, for example, can represent an exemplary embodiment of the RRC layer module 406.

### CONCLUSION

It is to be appreciated that the Detailed Description section, and not the Abstract section, is intended to be used to interpret the claims. The Abstract section may set forth one or more, but not all exemplary embodiments, of the present disclosure, and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus the present disclosure should not be limited by any of the above-described exemplary embodiments, but should be defined only in accordance with the following claims and their equivalents.

What is claimed is:

1. A mobile communication device for prioritizing traffic in a cellular network, comprising:
a radio configured to receive a prioritization command from a base station in the cellular network, the prioritization command being configured to cause the mobile communication device to prioritize voice traffic and video traffic over data traffic; and
a processor configured:
to classify traffic to be provided to the cellular network as being the voice traffic, the video traffic, or the data traffic,
to allow the voice traffic and the video traffic to be passed onto the radio for transmission to the cellular network, and
to prevent the data traffic from being passed onto the radio upon receiving the prioritization command from the radio.

2. The mobile communication device of claim 1, wherein the cellular network is configured to be operated in accordance with a long-term evolution (LTE) standard.

3. The mobile communication device of claim 1, wherein the prioritization command comprises:
a duration for which the mobile communication device is to prioritize the voice traffic and the video traffic over the data traffic.

4. The mobile communication device of claim 1, wherein the radio is further configured to receive a second prioritization command from the base station, the second prioritization command causing the mobile communication device to cease prioritizing the voice traffic and the video traffic over the data traffic.

5. The mobile communication device of claim 1, further comprising:
input/output components configured to provide a notification to a user of the mobile communication device that the mobile communication device is configured to cause the mobile communication device to prioritize the voice traffic and the video traffic over the data traffic.

6. The mobile communication device of claim 1, wherein the processor comprises:
a radio resource control (RRC) layer module configured to prioritize the voice traffic and the video traffic over the data traffic, and
a Non-Access Stratum (NAS) layer module configured to establish a communication session between the mobile communication device and the base station, and
wherein the radio comprises:
an Access Stratum (AS) layer module configured to communicate only the voice traffic and the video traffic between the mobile communication device and the base station during the communication session.

7. The mobile communication device of claim 6, wherein the RRC layer module comprises:
a broadcast of system information reception module configured to receive the prioritization command from a broadcast of system information transmitted by the base station to the mobile communication device;
a barring adjustment module configured to determine a duration from the prioritization command for which the mobile communication device is to prioritize the voice traffic and the video traffic over the data traffic; and
a Service Specific Access Control (SSAC) management module configured to prioritize the voice traffic and the video traffic over the data traffic during the duration.

8. A base station for prioritizing traffic in a cellular network, comprising:
a radio configured to send a prioritization command to a mobile communication device in the cellular network, the prioritization command being configured to cause the mobile communication device to prioritize voice traffic and video traffic over data traffic; and
a processor configured:
to interface with a network operator, a core network, or a traffic analyzer; and
to provide to the radio the prioritization command based on input from the network operator, the core network, or the traffic analyzer.

9. The base station of claim 8, wherein the cellular network is configured to be operated in accordance with a long-term evolution (LTE) standard.

10. The base station of claim 8, wherein the prioritization command comprises:
a duration for which the mobile communication device is to prioritize the voice traffic and the video traffic over the data traffic.

11. The base station of claim 8, wherein the base station is further configured to send a second prioritization command to the mobile communication device, the second prioritization command causing the mobile communication device to cease prioritizing the voice traffic and the video traffic over the data traffic.

12. The base station of claim 8, further comprising:
input/output components configured to provide a notification to at least one of the network operator or the core network that the mobile communication device is configured to cause the mobile communication device to prioritize the voice traffic and the video traffic over the data traffic.

13. The base station of claim 11, further comprising:
a traffic analyzer configured:
to monitor the usage in the cellular network;
to request the processor to issue the prioritization command should the usage in the cellular network exceed a threshold; and
to request the processor to issue the second prioritization command should usage in the cellular network drop below the threshold.

14. A method for prioritizing traffic in a cellular network, the method comprising:
establishing a mobile originating call between a mobile communication device and a base station;
sending, by a base station, a prioritization command to the mobile communication device;
receiving, by the mobile commutation device, the prioritization command from the base station;
classifying, by the mobile communication device, traffic to be provided to the cellular network as being voice traffic, video traffic, or data traffic;
allowing, by the mobile communication device, the voice traffic and the video traffic to be transmitted to the base station, and
preventing, by the mobile communication device, the data traffic from being transmitted to the base station upon receiving the prioritization command.

15. The method according to claim 14, further comprising:
configuring the cellular network to be operated in accordance with a long-term evolution (LTE) standard.

16. The method according to claim 14, the prioritization command comprising:
prioritizing the voice traffic and the video traffic over the data traffic for a duration.

17. The method according to claim 14, further comprising:
receiving at the radio, a second prioritization command from the base station, the second prioritization command causing the mobile communication device to cease prioritizing the voice traffic and the video traffic over the data traffic.

18. The method according to claim 14, further comprising:
notifying a user of the mobile communication device and at least one of a network operator or a core network, that the mobile communication device is configured to cause the mobile communication device to prioritize the voice traffic and the video traffic over the data traffic.

19. The method according to claim 17, further comprising:
monitoring the usage in the cellular network;
sending, by the base station, the prioritization command to the mobile communication device should the usage in the cellular network exceed a threshold; and
sending, by the base station, the second prioritization command to the mobile communication device should usage in the cellular network drop below the threshold.

20. The method according to claim 17, further comprising:
interfacing to a network operator or core network;
sending, by the base station, the prioritization command to the mobile communication device when directed to do so by the network operator or the core network; and
sending, by the base station, the second prioritization command to the mobile communication device when directed to do so by the network operator or the core network.
